(19) United States
(12) Patent Application Publication
(10) Pub. No.: US 2009/0034236 A1
(43) Pub. Date: Feb. 5, 2009

(54) Shoe With Ultraviolet LED Irradiated Photocatalyst Coated Surfaces.

(76) Inventor: David Isidore Reuben, Las Vegas, NV (US)

Correspondence Address: DAVID REUBEN, 10708 MOON FLOWER ARBOR PLACE, LAS VEGAS, NV, 89144, US

(21) Appl. No.: 12/198,310

(22) Filed: Aug. 26, 2008

Related U.S. Application Data
(63) Continuation of application No. 11/830,161, filed on Jul. 30, 2007.

(51) Int. Cl. F21V 21/08

(52) U.S. Cl. 362/103

(57) ABSTRACT

A shoe with ultraviolet LEDs embedded in a UV transmissive photocatalyst coated sole or positioned inside the upper to irradiate photocatalyst coated surfaces. Whereby the electrons released by the photocatalyst or the surface recombination effects present have efficacy in surface sanitization or in odor control.

### CROSS-REFERENCE TO RELATED APPLICATIONS

This is a continuation of application Ser. No. 11830161 filed 30, Jul. 2007

### DRAWINGS

### Figures

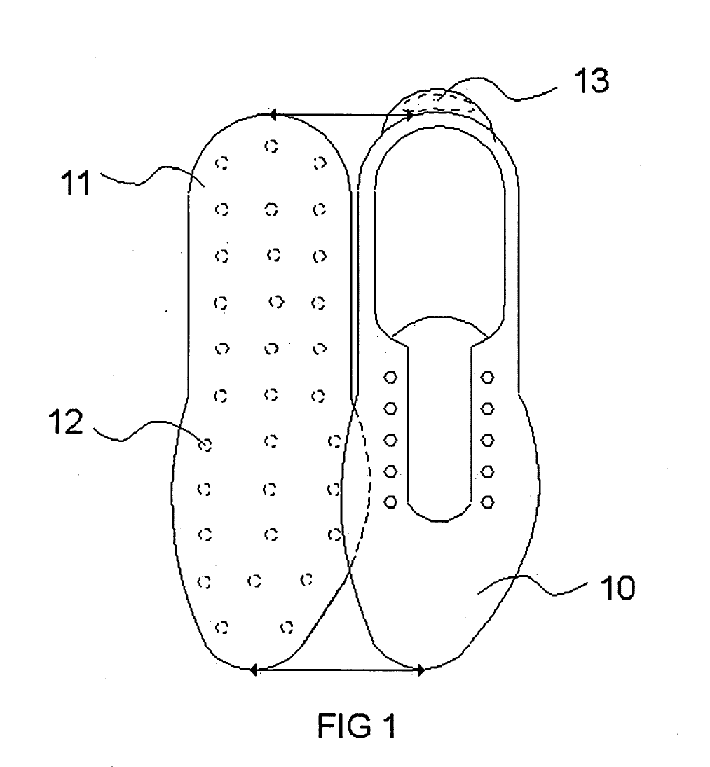

FIG. 1 Shows shoe upper overlaid on sole.

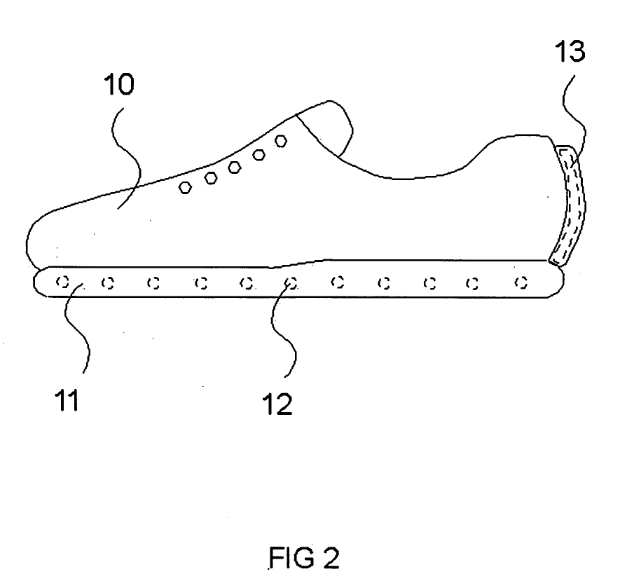

FIG. 2 Shows shoe side.

### REFERENCE NUMERALS

10 Shoe Upper
11 Shoe Sole
12 LED
13 Battery

### DETAILED DESCRIPTION

### FIGS. 1 and 2

FIG. 1 shows the shoe upper 10 overlaid on the shoe sole 11. In this embodiment the shoe upper 10 holds the battery 13 in an internal compartment at the rear of the shoe. In this embodiment the battery 13 is sealed in the shoe and is a rechargeable battery which is recharged by induction, a non contact battery charging technology common to other consumer products. The shoe sole 11 is shown with a plurality of embedded LEDs 12. In one embodiment of this shoe product the sole 11 is made from a UV transmissive flexible polymer material and the LEDs 12 are dies embedded in it. These LEDs can be oriented to irradiate the inside surface of the sole, the outside surface of the sole, or both. The surfaces of the sole and the surfaces inside of the upper can be coated or nanocoated with a photocatalyst. The sole 11 itself can also be made from a photocatalyst composite. In this embodiment the embedded LEDs 12 would irradiated the photocatalyst in order to cause a surface photocatalytic effect.

FIG. 2 shows the side of the shoe with the upper 10 attached to the sole 11. The battery 13 is shown at the rear of the shoe and is shown sealed within the shoe. In this embodiment the battery is again recharged by induction. The sole 11 is shown with the LEDs 12 embedded within it.

### ALTERNATIVE EMBODIMENTS

There are various possibilities with regard to the placement of the LEDs as well as the powering options and control circuitry options. FIGS. 1 and 2 show the LEDs embedded in the sole. An alternative embodiment would be to locate LED lamps within the upper that irradiate photocatalyst coated surfaces inside the upper directly. LED lamps could also be mounted in crevices on the inside or outside surface of the sole in order to irradiate a photocatalyst coating in the crevices. Alternative embodiments for the powering options include powering the LED circuit with a solar cell, making the battery 13 a replaceable battery or recharging a rechargeable battery through a plug in connection. In the case of the solar powered embodiment the solar cell may be a flexible one that is sewn into the upper preferably at the top of the tip. Control circuit options include the use of a foot presence sensor or switch, a built in timer circuit, or remote control activation means. Since direct exposure of the foot to UV may be undesirable, a foot presence sensor may be utilized to prevent this. This sensor may be a contact switch or an optical sensor. A built in timer circuit can be used to control irradiation time and frequency. A moisture sensor can also be integrated in order to use the technology for automatically drying the shoe.

### Operation

The threshold wavelength for titanium dioxide photocatalyst is 388 nm. At wavelengths below that the outer valence electron in the TiO2 molecule simply needs to absorb enough photons to have the energy to escape. It is this electron that is the catalyst for pathogen inactivation. This shoe invention uses this sanitizing technology in order to sanitize surfaces inside or outside the shoe. The sanitizing properties are useful in preventing foot fungus as well as in odor control and overall shoe cleanliness. Various embodiments of the shoe involve differing powering options and control circuits. A rechargeable battery embodiment version can be recharged by the consumer utilizing an induction recharging cradle. The consumer would place the shoe when not in use on the cradle in order to recharge the batteries. A solar cell version would have a solar cell sewn into the upper and the shoe would be completely self powered. A combination battery and solar cell version is also feasible. Sanitizing cycles can be initiated automatically or manually. Automatic cycles can be initiated be a sensor or switch or by a built in timer. Automatic cycles can also be initiated while the shoe is being recharged. Manual sanitizing cycles can be initiated by a push button on the shoe or by a remote control option. Consumers interested in a self sanitizing shoe would purchase the shoes as a set. This set would include either an induction recharging cradle or a recharging power adapter.

I claim:

1. A shoe with LEDs embedded in the sole or inside of the upper which irradiate one or more photocatalyst coated surfaces on or in the shoe in order to cause a surface photocatalytic effect.

2. Where the LEDs in claim 1 are UVA wavelength.

3. Where the photocatalyst in claim 1 is titanium dioxide.

4. Where the titanium dioxide photocatalyst in claim 3 is doped.

5. Where the doped titanium dioxide photocatalyst in claim 4 is doped with silver.

6. Where the LEDs in claim 1 are dies embedded in the sole.

7. Where the sole in claim 1 is made from a UV transmissive material.

8. Where the UV transmissive material in claim 7 is a photocatalyst composite polymer.

9. Where the LED circuit in claim 1 is powered by a battery.

10. Where the LED circuit in claim 1 is powered by a plug in adapter.

11. Where the battery in claim 9 is embedded in the shoe.

12. Where the embedded battery in claim 11 is rechargeable.

13. Where the rechargeable embedded battery in claim 12 is recharged by induction.

14. Where the rechargeable embedded battery in claim 12 is recharged using a plug in adapter.

15. Where the battery in claim 9 is a replaceable battery.

16. Where the LED circuit in claim 1 is powered by a solar cell sewn into the upper.

17. Where the solar cell in claim 16 is flexible.

18. Where the LED circuit in claim 1 is activated or deactivated by a foot presence sensor or switch.

19. Where the LED circuit in claim 1 is activated by remote control.

20. Where the LED circuit in claim 1 is activated by a moisture sensor.

21. Where the LED circuit in claim 1 is activated by a push button on the shoe.

22. Where the LED circuit in claim 1 is controlled by a timer circuit integral to the shoe.

23. Where the LEDs in claim 1 are digitally pulsed.

24. Where the LEDs in claim 1 are oriented to irradiate the inside surface of the sole.

25. Where the LEDs in claim 1 are oriented to irradiate the outer surface of the sole.

26. Where the LEDs in claim 1 are oriented to irradiate surfaces inside the upper.

27. Where the LEDs in claim 1 are oriented to irradiate crevices in the sole.

28. Where the LEDs in claim 1 utilize an integral heat sink system.

29. Where the sole in claim 1 utilizes integral vapor channels for moisture transmission.
